(19) United States
(12) Patent Application Publication
(10) Pub. No.: US 2019/0088217 A1
(43) Pub. Date: Mar. 21, 2019

(54) Pixel Structure and Liquid Crystal Display (LCD) Panel Thereof

(71) Applicant: Shenzhen China Star Optoelectronics Technology Co., LTD., Shenzhen (CN)

(72) Inventor: Jiang Zhu, Shenzhen (CN)

(21) Appl. No.: 15/312,623

(22) PCT Filed: Jul. 12, 2016
(86) PCT No.: PCT/CN2016/089711

§ 371 Date: Nov. 18, 2016

(30) Foreign Application Priority Data
Jun. 7, 2016 (CN) 201610402657.X

(51) Int. Cl. G09G 3/36; G02F 1/133

(52) U.S. Cl. CPC G09G 3/3614; G09G 3/3607; G09G 3/3674; G09G 2300/0452; G02F 1/13306; G09G 2300/0426; G09G 3/3685

(57) ABSTRACT

The present invention provides a structure including a plurality of data lines, a plurality of scan lines, and a plurality of pixel units disposed between the data lines and the scan lines. The mth pixel unit of (4n+1)th row connects to mth data line, mth pixel unit of (4n+2)th row connects to the mth data line, mth pixel unit of the (4n+3)th row connects to (m+2)th data line, and mth pixel unit of (4n+4)th row connects to the (m+2)th data line, where n is a non-positive integer and m is a positive integer. The present invention further provides a liquid crystal display (LCD) panel.

### BACKGROUND OF THE INVENTION

### Field of Invention

The present invention relates to a technical field of a liquid crystal display (LCD), and more particularly to a pixel structure and an LCD panel thereof.

### Description of Prior Art

With the development of liquid crystal display technology, how to achieve a higher screen quality becomes a major indicator of the product competition of the display panel manufacturers where the main factors of the screen quality affecting the LCD panel are the issues of crosstalk and flicker phenomena occurring on the screen.

Currently, the pixel structures of the LCD panel with better solutions of the crosstalk and flicker phenomena on the screen are depicted in FIGS. 1A and 1B. FIG. 1A is a schematic view of a plurality of pixel polarities of a plurality of pixel units arranged in an odd frame of a conventional pixel structure. FIG. 1B is a schematic view of a plurality of pixel polarities of the pixel units arranged in an even frame of the conventional pixel structure. As show in FIGS. 1A and 1B, the pixel structure adopts a two-line inversion configuration. In other words, the pixel polarities of the pixel units in two adjacent rows are the same and the pixel polarities of the pixel units in two adjacent columns are the same to avoid the crosstalk and flicker phenomena.

When the pixel structure displays the frames and after every two rows of the pixel units are scanned, it is required that the driving circuit corresponding to all of the data lines need to convert the polarities of the data line signals, thereby resulting in the increasing power consumption of the driving circuit of the LCD panel. Furthermore, the temperature of driving chips of the driving circuit increases and affects the display stability.

Consequently, there is a need to develop a pixel structure and an LCD panel thereof to solve the problems of the conventional technique.

### SUMMARY OF THE INVENTION

The pixel structure and LCD panel thereof of the present invention can reduce the power consumption of the LCD panel and improve the display quality of the LCD panel to solve the problems of the increasing power consumption and display stability of the driving circuit of the pixel structure and LCD panel.

The present invention provides a pixel structure including a plurality of data lines, a plurality of scan lines, and a plurality of pixel units disposed between the data lines and the scan lines, where:

mth pixel unit of (4n+1)th row connects to mth data line, mth pixel unit of (4n+2)th row connects to the mth data line, mth pixel unit of the (4n+3)th row connects to (m+2)th data line, and mth pixel unit of (4n+4)th row connects to the (m+2)th data line;

a polarity of the mth pixel unit of the (4n+1)th row and a polarity of the mth pixel unit of the (4n+2)th row are the same, the polarity of the mth pixel unit of the (4n+2)th row and a polarity of mth pixel unit of the (4n+3)th row are opposite, and the polarity of the mth pixel unit of the (4n+3)th row and a polarity of the mth pixel unit of the (4n+4)th row are the same; and

a polarity of mth pixel unit of (4n+1)th column and a polarity of mth pixel unit of (4n+2)th column are the same, a polarity of mth the pixel unit of the (4n+2)th column and a polarity of mth pixel unit of (4n+3)th column are opposite, and a polarity of the mth pixel unit of the (4n+3)th column and a polarity of mth pixel unit of (4n+4)th column are the same; wherein n is a non-positive integer and m is a positive integer.

In one embodiment of the pixel structure, a plurality of polarities of a plurality of data signals in the data lines of adjacent frames having a plurality of the pixel units are converted.

In one embodiment of the pixel structure, the pixel unit of ath row connects to ath scan line, and a is a positive integer.

In one embodiment of the pixel structure, the pixel structure comprises a pixel unit with a red color, a pixel unit with a green color, and a pixel unit with a blue color.

In one embodiment of the pixel structure, the pixel structure comprises a pixel unit with a red color, a pixel unit with a green color, a pixel unit with a blue color, and a pixel unit with a white color.

In one embodiment of the pixel structure, the polarity of the mth pixel unit of the (4n+1)th row and a polarity of mth pixel unit of (4n+5)th row are the same.

In one embodiment of the pixel structure, the polarity of the mth pixel unit of the (4n+1)th column and a polarity of mth pixel unit of (4n+5)th column are the same.

The present invention provides a pixel structure comprising a plurality of data lines, a plurality of scan lines, and a plurality of pixel units disposed between the data lines and the scan lines, wherein:

mth pixel unit of (4n+1)th row connects to mth data line, mth pixel unit of (4n+2)th row connects to the mth data line, mth pixel unit of (4n+3)th row connects to (m+2)th data line, and mth pixel unit of (4n+4)th row connects to the (m+2)th data line;

a polarity of the mth pixel unit of the (4n+1)th row and a polarity of the mth pixel unit of the (4n+2)th row are the same, the polarity of the mth pixel unit of the (4n+2)th row and a polarity of the mth pixel unit of the (4n+3)th row are opposite, and the polarity of the mth pixel unit of the (4n+3)th row and a polarity of the mth pixel unit of the (4n+4)th row are the same; and

a polarity of mth pixel unit of (4n+1)th column and a polarity of mth pixel unit of (4n+2)th column are opposite, the polarity of the mth pixel unit of the (4n+2)th column and a polarity of mth pixel unit of (4n+3)th column are the same, and the polarity of the mth pixel unit of the (4n+3)th column and a polarity of mth pixel unit of the (4n+4)th column are opposite; wherein n is a non-positive integer and m is a positive integer.

In one embodiment of the pixel structure, a plurality of polarities of a plurality of data signals in the data lines of adjacent frames having a plurality of the pixel units are converted.

In one embodiment of the pixel structure, the pixel unit of ath row connects to ath scan line, and a is a positive integer.

In one embodiment of the pixel structure, the pixel structure comprises a pixel unit with a red color, a pixel unit with a green color, and a pixel unit with a blue color.

In one embodiment of the pixel structure, the pixel structure comprises a pixel unit with a red color, a pixel unit with a green color, a pixel unit with a blue color, and a pixel unit with a white color.

In one embodiment of the pixel structure, the polarity of the mth pixel unit of the (4n+1)th row and a polarity of mth pixel unit of (4n+5)th row are the same.

In one embodiment of the pixel structure, the polarity of the mth pixel unit of the (4n+1)th column and a polarity of mth pixel unit of (4n+5)th column are the same.

The present invention provides a liquid crystal display (LCD) panel comprising a pixel structure and a driving circuit to drive the pixel structure, and the pixel structure comprising a plurality of data lines, a plurality of scan lines, and a plurality of pixel units disposed between the data lines and the scan lines, wherein:

mth pixel unit of (4n+1)th row connects to mth data line, mth pixel unit of (4n+2)th row connects to the mth data line, mth pixel unit of the (4n+3)th row connects to (m+2)th data line, and mth pixel unit of (4n+4)th row connects to the (m+2)th data line;

a polarity of the mth pixel unit of the (4n+1)th row and a polarity of the mth pixel unit of the (4n+2)th row are the same, the polarity of the mth pixel unit of the (4n+2)th row and a polarity of mth pixel unit of the (4n+3)th row are opposite, and the polarity of the mth pixel unit of the (4n+3)th row and a polarity of the mth pixel unit of the (4n+4)th row are the same; and

a polarity of mth pixel unit of (4n+1)th column and a polarity of mth pixel unit of (4n+2)th column are the same, a polarity of mth the pixel unit of the (4n+2)th column and a polarity of mth pixel unit of (4n+3)th column are opposite, and a polarity of the mth pixel unit of the (4n+3)th column and a polarity of mth pixel unit of (4n+4)th column are the same; wherein n is a non-positive integer and m is a positive integer.

In one embodiment of the LCD panel, a plurality of polarities of a plurality of data signals in the data lines of adjacent frames having a plurality of the pixel units are converted.

In one embodiment of the LCD panel, the pixel unit of ath row connects to ath scan line, and a is a positive integer.

In one embodiment of the LCD panel, the pixel structure comprises a pixel unit with a red color, a pixel unit with a green color, and a pixel unit with a blue color.

In one embodiment of the LCD panel, the pixel structure comprises a pixel unit with a red color, a pixel unit with a green color, a pixel unit with a blue color, and a pixel unit with a white color.

In comparison to the conventional pixel structure and LCD panel, the pixel structure and LCD panel of the present invention are configured to drive the (4n+3)th and (4n+4)th rows using (m+2)th data line such that based on the two-line row inversion and two-line column inversion, the pixel structure and LCD panel thereof can reduce the inverse frequencies of the data signals of each frame according to one embodiment of the present invention, thereby reducing the power consumption of the LCD panel and improving the display quality of the LCD panel to solve the problems of the increasing power consumption and display stability of the driving circuit of the pixel structure and LCD panel.

### BRIEF DESCRIPTION OF THE DRAWINGS

The following embodiments refer to the accompanying drawings for exemplifying specific implementable embodiments of the present invention. The drawings are only some embodiments of the present invention. Persons skilled in the art should be noted that other accompanying drawings can be obtained on the basis of the above-depicted drawings.

FIG. 1A is a schematic view of a plurality of pixel polarities of a plurality of pixel units arranged in an odd frame of a conventional pixel structure;

FIG. 1B is a schematic view of a plurality of pixel polarities of the pixel units arranged in an even frame of the conventional pixel structure;

FIG. 2A is a schematic view of a pixel structure displaying the odd frame according to a first embodiment of the present invention;

FIG. 2B is a schematic view of a pixel structure displaying the even frame according to a first embodiment of the present invention;

FIG. 3A is a schematic view of a pixel structure displaying the odd frame according to a second embodiment of the present invention; and

FIG. 3B is a schematic view of a pixel structure displaying the even frame according to a second embodiment of the present invention.

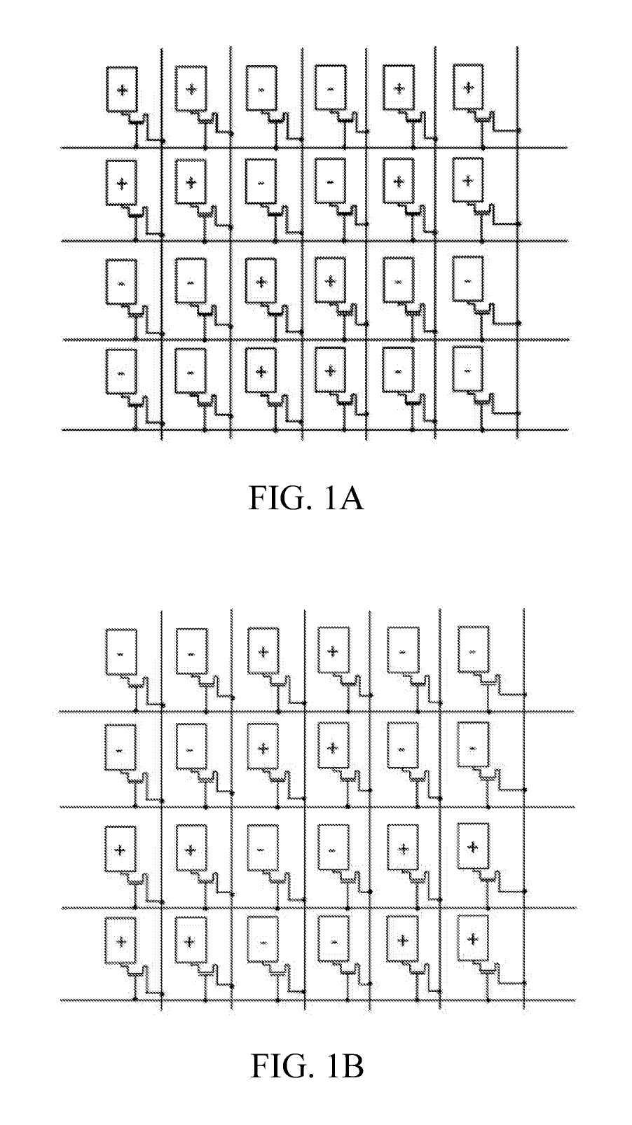

### DETAILED DESCRIPTION OF THE PREFERRED EMBODIMENTS

In the drawings, the same reference symbol represents the same or a similar component. The foregoing preferred embodiments of the present invention are illustrative rather than limiting of the present invention.

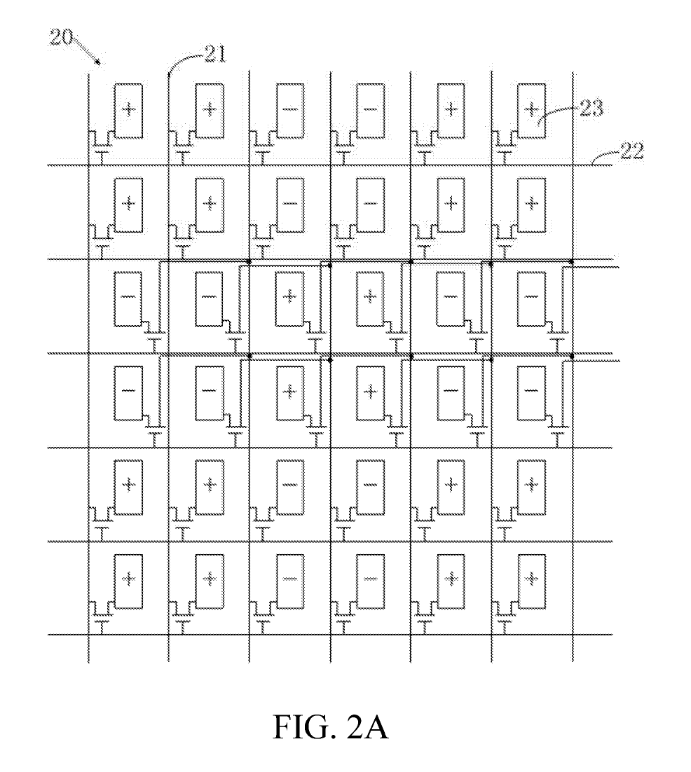

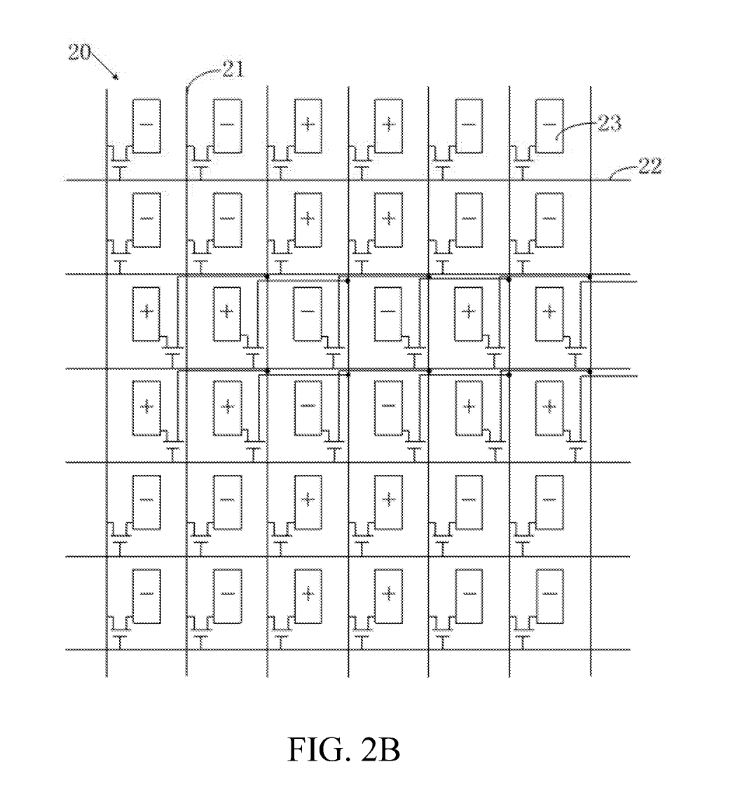

FIG. 2A is a schematic view of a pixel structure displaying an odd frame according to a first preferred embodiment of the present invention. FIG. 2B is a schematic view of a pixel structure displaying the even frame according to the first preferred embodiment of the present invention. The pixel structure 20 includes a plurality of data lines 21, a plurality of scan lines 22 and a plurality of pixel units 23 disposed between the data lines 21 and the scan lines 22, where the connection relationship of the pixel units 23 to the data lines 21 and the scan lines 22 are described as follows.

The mth pixel unit of the (4n+1)th row connects to mth data line, the mth pixel unit of the (4n+2)th row connects to mth data line, the mth pixel unit of the (4n+3)th row connects to (m+2)th data line, and the mth pixel unit of the (4n+4)th row connects to (m+2)th data line.

The polarity of mth pixel unit of the (4n+1)th row and the polarity of mth pixel unit of the (4n+2)th row are the same. The polarity of mth pixel unit of the (4n+2)th row and the polarity of mth pixel unit of the (4n+3)th row are opposite. The polarity of mth pixel unit of the (4n+3)th row and the polarity of mth pixel unit of the (4n+4)th row are the same.

The polarity of mth pixel unit of the (4n+1)th column and the polarity of mth pixel unit of the (4n+2)th column are the same. The polarity of mth pixel unit of the (4n+2)th column and the polarity of mth pixel unit of the (4n+3)th column are opposite. The polarity of mth pixel unit of the (4n+3)th column and the polarity of mth pixel unit of the (4n+4)th column are the same.

The polarity of mth pixel unit of the (4n+1)th row and the polarity of mth pixel unit of the (4n+5)th row are the same. The polarity of mth pixel unit of the (4n+1)th column and the polarity of mth pixel unit of the (4n+5)th column are the same. In the above-mentioned descriptions of the present invention, nth is a non-positive integer and mth is a positive integer.

The pixel unit of ath row connects to the ath scan line, where ath is a positive integer.

In one embodiment, when the pixel structure displays the frames, the polarities of the pixel units of the pixel structure are configured to be a two-line row inversion and two-line column inversion. In other words, the pixel polarities of pixel units are inverted at two-row intervals and the pixel polarities of pixel units are inverted at two-column intervals to ensure a better display quality of the LCD panel.

As shown in FIG. 2A, when the pixel structure displays the odd frames, the polarities of the pixel units 23 in the first column and second column of the first row are positive, the polarities of the pixel units 23 in the third row and fourth row of the first column are negative, . . . , the polarities of the pixel units 23 in the (4n+1)th row and (4n+2)th row of the first column are positive, and the polarities of the pixel units 23 in the (4n+3)th row and (4n+4)th row of the first column are negative.

The polarities of the pixel units 23 in the first column and second column of the second row are positive, the polarities of the pixel units 23 in the third column and fourth column of the second row are negative, . . . , the polarities of the pixel units 23 in the (4n+1)th column and (4n+2)th column of the second row are positive, and the polarities of the pixel units 23 in the (4n+3)th column and (4n+4)th column of the second row are negative.

The polarities of the pixel units 23 in the first column and second column of the third row are negative, the polarities of the pixel units 23 in the third column and fourth column of the third row are positive, . . . , the polarities of the pixel units 23 in the (4n+1)th column and (4n+2)th column of the third row are negative, and the polarities of the pixel units 23 in the (4n+3)th column and (4n+4)th column of the third row are positive.

The polarities of the pixel units 23 in the first column and second column of the fourth row are negative, the polarities of the pixel units 23 in the third column and fourth column of the fourth row are positive, . . . , the polarities of the pixel units 23 in the (4n+1)th column and (4n+2)th column of the fourth row are negative, the polarities of the pixel units 23 in the (4n+3)th column and (4n+4)th column of the fourth row are positive, and so forth.

The polarities of the pixel units 23 in the first column and second column of the (4n+1) row are positive, the polarities of the pixel units 23 in the third column and fourth column of the (4n+1) row are negative, . . . , the polarities of the pixel units 23 in the (4n+1)th column and (4n+2)th column of the (4n+1) row are positive, and the polarities of the pixel units 23 in the (4n+3)th column and (4n+4)th column of the (4n+1) row are negative.

The polarities of the pixel units 23 in the first column and second column of the (4n+2)th row are positive, the polarities of the pixel units 23 in the third column and fourth column of the (4n+2)th row are negative, . . . , the polarities of the pixel units 23 in the (4n+1)th column and (4n+2)th column of the (4n+2)th row are positive, and the polarities of the pixel units 23 in the (4n+3)th column and (4n+4)th column of the (4n+2)th row are negative.

The polarities of the pixel units 23 in the first column and second column of the (4n+3)th row are negative, the polarities of the pixel units 23 in the third column and fourth column of the (4n+3)th row are positive, . . . , the polarities of the pixel units 23 in the (4n+1)th column and (4n+2)th column of the (4n+3)th row are negative, and the polarities of the pixel units 23 in the (4n+3)th column and (4n+4)th column of the (4n+3)th row are positive.

The polarities of the pixel units 23 in the first column and second column of the (4n+4)th row are negative, the polarities of the pixel units 23 in the third column and fourth column of the (4n+4)th row are positive, . . . , the polarities of the pixel units 23 in the (4n+1)th column and (4n+2)th column of the (4n+4)th row are negative, and the polarities of the pixel units 23 in the (4n+3)th column and (4n+4)th column of the (4n+4)th row are positive.

In one embodiment, the pixel structure 20 scans the data lines of the pixels units 23 of the odd frames by an example of first six columns of the data lines 21. When the scan line 22 scans the pixel units 23 of the first row, the polarities of the data signals from the data lines 21 of the first column to the data lines 21 of the sixth column are positive, positive, negative, negative, positive, and positive statuses respectively. When the scan line 22 scans the pixel units 23 of the second row, the polarities of the data signals from the data lines 21 of the first column to the data lines 21 of the sixth column are still positive, positive, negative, negative, positive, and positive statuses respectively. When the scan line 22 scans the pixel units 23 of the third row, the polarities of the data signals from the data lines 21 of the first column to the data lines 21 of the sixth column are still positive, positive, negative, negative, positive, and positive statuses respectively. When the scan line 22 scans the pixel units 23 of the fourth row, the polarities of the data signals from the data lines 21 of the first column to the data lines 21 of the sixth column are still positive, positive, negative, negative, positive, and positive statuses respectively, and so forth.

When the scan line 22 scans the pixel units 23 of the (4n+1)th row, the polarities of the data signals from the data lines 21 of the first column to the data lines 21 of the sixth column are positive, positive, negative, negative, positive, and positive statuses respectively. When the scan line 22 scans the pixel units 23 of the (4n+2)th row, the polarities of the data signals from the data lines 21 of the first column to the data lines 21 of the sixth column are still positive, positive, negative, negative, positive, and positive statuses respectively. When the scan line 22 scans the pixel units 23 of the (4n+3)th row, the polarities of the data signals from the data lines 21 of the first column to the data lines 21 of the sixth column are still positive, positive, negative, negative, positive, and positive statuses respectively. When the scan line 22 scans the pixel units 23 of the (4n+4)th row, the polarities of the data signals from the data lines 21 of the first column to the data lines 21 of the sixth column are still positive, positive, negative, negative, positive, and positive statuses respectively.

In other words, the polarities of the data signals of the data lines 21 in the same frame are not inverted.

As shown in FIG. 2B, the polarities of the pixel structure 20 displaying the even frames are opposite to the polarities of the pixel structure 20 displaying the odd frames.

In one embodiment, the pixel structure 20 scans the data lines of the pixels units 23 of the even frames by an example of first six columns of the data lines 21. When the scan line 22 scans the pixel units 23 of the first row, the polarities of the data signals from the data lines 21 of the first column to the data lines 21 of the sixth column are negative, negative, positive, positive, negative, and negative statuses respectively. When the scan line 22 scans the pixel units 23 of the second row, the polarities of the data signals from the data lines 21 of the first column to the data lines 21 of the sixth column are still negative, negative, positive, positive, negative, and negative statuses respectively. When the scan line 22 scans the pixel units 23 of the third row, the polarities of the data signals from the data lines 21 of the first column to the data lines 21 of the sixth column are still negative, negative, positive, positive, negative, and negative statuses respectively. When the scan line 22 scans the pixel units 23 of the fourth row, the polarities of the data signals from the data lines 21 of the first column to the data lines 21 of the sixth column are still negative, negative, positive, positive, negative, and negative statuses respectively, and so forth.

When the scan line 22 scans the pixel units 23 of the (4n+1)th row, the polarities of the data signals from the data lines 21 of the first column to the data lines 21 of the sixth column are negative, negative, positive, positive, negative, and negative statuses respectively. When the scan line 22 scans the pixel units 23 of the (4n+2)th row, the polarities of the data signals from the data lines 21 of the first column to the data lines 21 of the sixth column are still negative, negative, positive, positive, negative, and negative statuses respectively. When the scan line 22 scans the pixel units 23 of the (4n+3)th row, the polarities of the data signals from the data lines 21 of the first column to the data lines 21 of the sixth column are still negative, negative, positive, positive, negative, and negative statuses respectively. When the scan line 22 scans the pixel units 23 of the (4n+4)th row, the polarities of the data signals from the data lines 21 of the first column to the data lines 21 of the sixth column are still negative, negative, positive, positive, negative, and negative statuses respectively.

In other words, the polarities of the data signals of the data lines 21 in the same frame are not inverted.

Therefore, the pixel structure 20 can reduce the inverse frequencies of the data signals of each frame according to one embodiment of the present invention.

In one embodiment, the pixel structure 20 depicts the relationship between the pixel units 23, data lines 21 and scan lines in the central portion of the LCD panel. Based on the polarity characteristic of the above-mentioned pixel units, a dedicated data lines 21 is connected to the pixel unit 23 in the side portion of the LCD panel, thereby decreasing the cost of the manufacturing cost of the LCD panel.

In one embodiment, the pixel structure 20 includes a pixel unit with red color, a pixel unit with green color, and a pixel unit with blue color. In another embodiment, the pixel structure 20 includes a pixel unit with red color, a pixel unit with green color, a pixel unit with blue color, and a pixel unit with white color. The user selects the kind of pixel units of the pixel structure based on design requirement.

The pixel structure 20 can reduce the inverse frequencies of the data signals of each frame according to one embodiment of the present invention, where the inverse frequency of the data signals in each frame is once, thereby reducing the power consumption of the LCD panel and improving the display stability of the LCD panel.

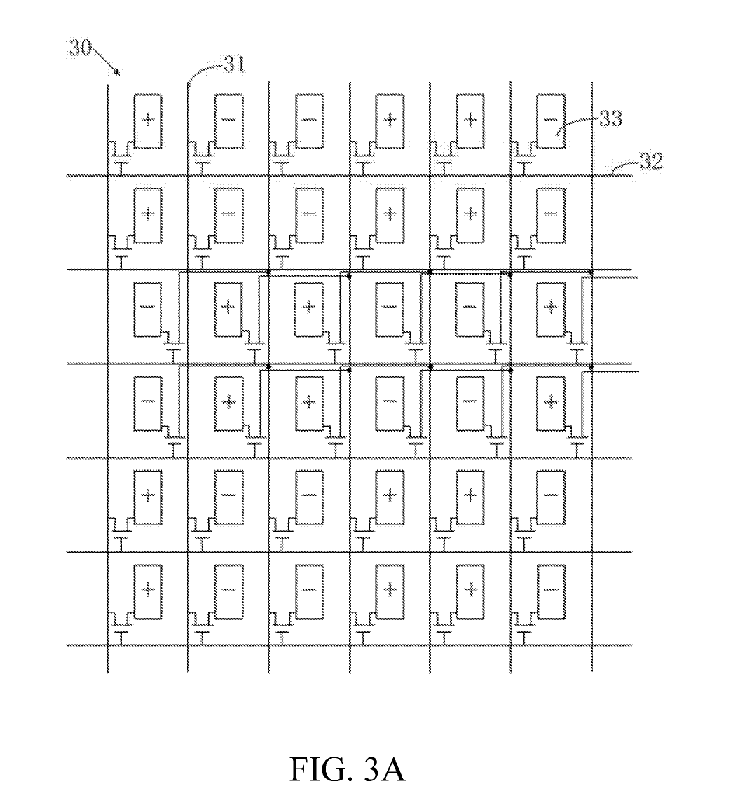

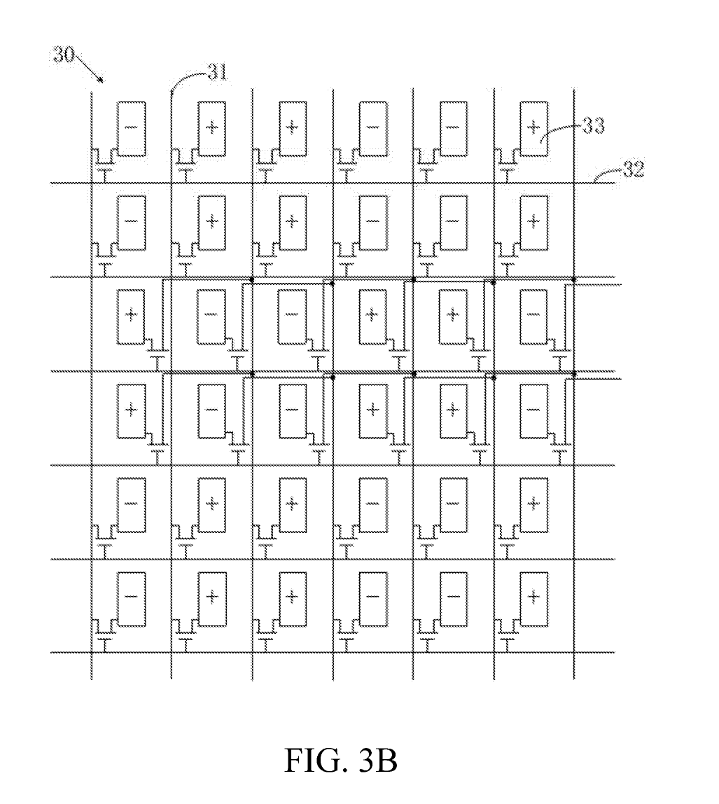

FIG. 3A is a schematic view of a pixel structure displaying the odd frame according to a second embodiment of the present invention. FIG. 3B is a schematic view of a pixel structure displaying the even frame according to a second embodiment of the present invention. The pixel structure 30 includes a plurality of data lines 31, a plurality of scan lines 32 and a plurality of pixel units 33 disposed between the data lines 31 and the scan lines 32, where the connection relationship of the pixel units 33 to the data lines 31 and the scan lines 32 are described as follows.

The mth pixel unit of the (4n+1)th row connects to mth data line, the mth pixel unit of the (4n+2)th row connects to mth data line, the mth pixel unit of the (4n+3)th row connects to (m+2)th data line, and the mth pixel unit of the (4n+4)th row connects to (m+2)th data line.

The polarity of mth pixel unit of the (4n+1)th row and the polarity of mth pixel unit of the (4n+2)th row are the same. The polarity of mth pixel unit of the (4n+2)th row and the polarity of mth pixel unit of the (4n+3)th row are opposite. The polarity of mth pixel unit of the (4n+3)th row and the polarity of mth pixel unit of the (4n+4)th row are the same.

The polarity of mth pixel unit of the (4n+1)th column and the polarity of mth pixel unit of the (4n+2)th column are opposite. The polarity of mth pixel unit of the (4n+2)th column and the polarity of mth pixel unit of the (4n+3)th column are the same. The polarity of mth pixel unit of the (4n+3)th column and the polarity of mth pixel unit of the (4n+4)th column are opposite.

The polarity of mth pixel unit of the (4n+1)th row and the polarity of mth pixel unit of the (4n+5)th row are the same. The polarity of mth pixel unit of the (4n+1)th column and the polarity of mth pixel unit of the (4n+5)th column are the same. In the above-mentioned descriptions of the present invention, nth is a non-positive integer and mth is a positive integer.

The pixel unit of ath row connects to the ath scan line, where ath is a positive integer.

As shown in FIG. 3A, when the pixel structure displays the odd frames, the polarities of the pixel units 33 in the first column and fourth column of the first row are positive, the polarities of the pixel units 33 in the second row and third row of the first column are negative, . . . , the polarities of the pixel units 33 in the (4n+1)th row and (4n+4)th row of the first column are positive, and the polarities of the pixel units 33 in the (4n+2)th row and (4n+3)th row of the first column are negative.

The polarities of the pixel units 33 in the first column and fourth column of the second row are positive, the polarities of the pixel units 33 in the second column and third column of the second row are negative, . . . , the polarities of the pixel units 33 in the (4n+1)th column and (4n+4)th column of the second row are positive, and the polarities of the pixel units 33 in the (4n+2)th column and (4n+3)th column of the second row are negative.

The polarities of the pixel units 33 in the first column and fourth column of the third row are negative, the polarities of the pixel units 33 in the second column and third column of the third row are positive, . . . , the polarities of the pixel units 33 in the (4n+1)th column and (4n+4)th column of the third row are negative, and the polarities of the pixel units 33 in the (4n+2)th column and (4n+3)th column of the third row are positive.

The polarities of the pixel units 33 in the first column and fourth column of the fourth row are negative, the polarities of the pixel units 33 in the second column and third column of the fourth row are positive, . . . , the polarities of the pixel units 33 in the (4n+1)th column and (4n+4)th column of the fourth row are negative, the polarities of the pixel units 33 in the (4n+2)th column and (4n+3)th column of the fourth row are positive, and so forth.

The polarities of the pixel units 33 in the first column and fourth column of the (4n+1) row are positive, the polarities of the pixel units 33 in the second column and third column of the (4n+1) row are negative, . . . , the polarities of the pixel units 33 in the (4n+1)th column and (4n+4)th column of the (4n+1) row are positive, and the polarities of the pixel units 33 in the (4n+2)th column and (4n+3)th column of the (4n+1) row are negative.

The polarities of the pixel units 33 in the first column and fourth column of the (4n+2)th row are positive, the polarities of the pixel units 33 in the second column and third column of the (4n+2)th row are negative, . . . , the polarities of the pixel units 33 in the (4n+1)th column and (4n+4)th column of the (4n+2)th row are positive, and the polarities of the pixel units 33 in the (4n+2)th column and (4n+3)th column of the (4n+2)th row are negative.

The polarities of the pixel units 33 in the first column and fourth column of the (4n+3)th row are negative, the polarities of the pixel units 33 in the second column and third column of the (4n+3)th row are positive, . . . , the polarities of the pixel units 33 in the (4n+1)th column and (4n+4)th column of the (4n+3)th row are negative, and the polarities of the pixel units 33 in the (4n+2)th column and (4n+3)th column of the (4n+3)th row are positive.

The polarities of the pixel units 33 in the first column and fourth column of the (4n+4)th row are negative, the polarities of the pixel units 33 in the second column and third column of the (4n+4)th row are positive, . . . , the polarities of the pixel units 33 in the (4n+1)th column and (4n+4)th column of the (4n+4)th row are negative, and the polarities of the pixel units 33 in the (4n+2)th column and (4n+3)th column of the (4n+4)th row are positive.

In one embodiment, the pixel structure 30 scans the data lines of the pixels units 33 of the odd frames using an example of first six columns of the data lines 31. When the scan line 32 scans the pixel units 33 of the first row, the polarities of the data signals from the data lines 31 of the first column to the data lines 31 of the sixth column are positive, negative, negative, positive, positive, and negative statuses respectively. When the scan line 32 scans the pixel units 33 of the second row, the polarities of the data signals from the data lines 31 of the first column to the data lines 31 of the sixth column are still positive, negative, negative, positive, positive, and negative statuses respectively. When the scan line 32 scans the pixel units 33 of the third row, the polarities of the data signals from the data lines 31 of the first column to the data lines 31 of the sixth column are still positive, negative, negative, positive, positive, and negative statuses respectively. When the scan line 32 scans the pixel units 33 of the fourth row, the polarities of the data signals from the data lines 31 of the first column to the data lines 31 of the sixth column are still positive, negative, negative, positive, positive, and negative statuses respectively, and so forth.

When the scan line 32 scans the pixel units 33 of the (4n+1)th row, the polarities of the data signals from the data lines 31 of the first column to the data lines 31 of the sixth column are positive, positive, negative, negative, positive, and positive statuses respectively. When the scan line 32 scans the pixel units 33 of the (4n+2)th row, the polarities of the data signals from the data lines 31 of the first column to the data lines 31 of the sixth column are still positive, positive, negative, negative, positive, and positive statuses respectively. When the scan line 32 scans the pixel units 33 of the (4n+3)th row, the polarities of the data signals from the data lines 31 of the first column to the data lines 31 of the sixth column are still positive, positive, negative, negative, positive, and positive statuses respectively. When the scan line 32 scans the pixel units 33 of the (4n+4)th row, the polarities of the data signals from the data lines 31 of the first column to the data lines 31 of the sixth column are still positive, positive, negative, negative, positive, and positive statuses respectively.

In other words, the polarities of the data signals of the data lines 31 in the same frame are not inverted.

As shown in FIG. 3B, the polarities of the pixel structure 30 displaying the even frames are opposite to the polarities of the pixel structure 30 displaying the odd frames.

In one embodiment, the pixel structure 30 scans the data lines of the pixels units 33 of the even frames by an example of first six columns of the data lines. When the scan line 32 scans the pixel units 33 of the first row, the polarities of the data signals from the data lines of the first column to the data lines of the sixth column are negative, positive, positive, negative, negative, and positive statuses respectively. When the scan line 32 scans the pixel units 33 of the second row, the polarities of the data signals from the data lines of the first column to the data lines of the sixth column are still negative, positive, positive, negative, negative, and positive statuses respectively. When the scan line 32 scans the pixel units 33 of the third row, the polarities of the data signals from the data lines of the first column to the data lines of the sixth column are still negative, positive, positive, negative, negative, and positive statuses respectively. When the scan line 32 scans the pixel units 33 of the fourth row, the polarities of the data signals from the data lines of the first column to the data lines of the sixth column are still negative, positive, positive, negative, negative, and positive statuses respectively, and so forth.

When the scan line 32 scans the pixel units 33 of the (4n+1)th row, the polarities of the data signals from the data lines of the first column to the data lines of the sixth column are negative, positive, positive, negative, negative, and positive statuses respectively. When the scan line 32 scans the pixel units 33 of the (4n+2)th row, the polarities of the data signals from the data lines of the first column to the data lines of the sixth column are still negative, positive, positive, negative, negative, and positive statuses respectively. When the scan line 32 scans the pixel units 33 of the (4n+3)th row, the polarities of the data signals from the data lines of the first column to the data lines of the sixth column are still negative, positive, positive, negative, negative, and positive statuses respectively. When the scan line 32 scans the pixel units 33 of the (4n+4)th row, the polarities of the data signals from the data lines of the first column to the data lines of the sixth column are still negative, positive, positive, negative, negative, and positive statuses respectively.

In other words, the polarities of the data signals of the data lines 31 in the same frame are not inverted.

Therefore, the pixel structure 30 can reduce the inverse frequencies of the data signals of each frame according to one embodiment of the present invention.

In one embodiment, the pixel structure 30 depicts the relationship between the pixel units 33, data lines 31 and scan lines in the central portion of the LCD panel. Based on the polarity characteristic of the above-mentioned pixel units, a dedicated data line 31 is connected to the pixel unit 33 in the side portion of the LCD panel, thereby decreasing the cost of the manufacturing cost of the LCD panel.

In one embodiment, the pixel structure 30 includes a pixel unit with red color, a pixel unit with green color, and a pixel unit with blue color. In another embodiment, the pixel structure 30 includes a pixel unit with red color, a pixel unit with green color, a pixel unit with blue color, and a pixel unit with white color. The user selects the kind of pixel units of the pixel structure based on design requirement.

The pixel structure 30 can reduce the inverse frequencies of the data signals of each frame according to one embodiment of the present invention, thereby reducing the power consumption of the LCD panel and improving the display stability of the LCD panel.

The present invention further provides an LCD panel including the pixel structure and panel driving circuit, as described in the above, where the pixel structure includes data lines, scan lines and pixel units disposed between the data lines and scan lines.

The operational theorem of the LCD panel is the same as or similar to the above-mentioned pixel structure, as described above.

The pixel structure and LCD panel thereof can reduce the inverse frequencies of the data signals of each frame according to one embodiment of the present invention, thereby reducing the power consumption of the LCD panel and improving the display quality of the LCD panel to solve the problems of the increasing power consumption and display stability of the driving circuit of the pixel structure and LCD panel.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A pixel structure comprising a plurality of data lines, a plurality of scan lines, and a plurality of pixel units disposed between the data lines and the scan lines, wherein:
mth pixel unit of (4n+1)th row connects to mth data line, mth pixel unit of (4n+2)th row connects to the mth data line, mth pixel unit of the (4n+3)th row connects to (m+2)th data line, and mth pixel unit of (4n+4)th row connects to the (m+2)th data line;
a polarity of the mth pixel unit of the (4n+1)th row and a polarity of the mth pixel unit of the (4n+2)th row are the same, the polarity of the mth pixel unit of the (4n+2)th row and a polarity of mth pixel unit of the (4n+3)th row are opposite, and the polarity of the mth pixel unit of the (4n+3)th row and a polarity of the mth pixel unit of the (4n+4)th row are the same; and
a polarity of mth pixel unit of (4n+1)th column and a polarity of mth pixel unit of (4n+2)th column are the same, a polarity of mth the pixel unit of the (4n+2)th column and a polarity of mth pixel unit of (4n+3)th column are opposite, and a polarity of the mth pixel unit of the (4n+3)th column and a polarity of mth pixel unit of (4n+4)th column are the same;
wherein n is a non-positive integer and m is a positive integer.

2. The pixel structure of claim 1, wherein a plurality of polarities of a plurality of data signals in the data lines of adjacent frames having a plurality of the pixel units are converted.

3. The pixel structure of claim 1, wherein the pixel unit of ath row connects to ath scan line, and a is a positive integer.

4. The pixel structure of claim 1, wherein the pixel structure comprises a pixel unit with a red color, a pixel unit with a green color, and a pixel unit with a blue color.

5. The pixel structure of claim 1, wherein the pixel structure comprises a pixel unit with a red color, a pixel unit with a green color, a pixel unit with a blue color, and a pixel unit with a white color.

6. The pixel structure of claim 1, wherein the polarity of the mth pixel unit of the (4n+1)th row and a polarity of mth pixel unit of (4n+5)th row are the same.

7. The pixel structure of claim 1, wherein the polarity of the mth pixel unit of the (4n+1)th column and a polarity of mth pixel unit of (4n+5)th column are the same.

8. A pixel structure comprising a plurality of data lines, a plurality of scan lines, and a plurality of pixel units disposed between the data lines and the scan lines, wherein:
mth pixel unit of (4n+1)th row connects to mth data line, mth pixel unit of (4n+2)th row connects to the mth data line, mth pixel unit of (4n+3)th row connects to (m+2)th data line, and mth pixel unit of (4n+4)th row connects to the (m+2)th data line;
a polarity of the mth pixel unit of the (4n+1)th row and a polarity of the mth pixel unit of the (4n+2)th row are the same, the polarity of the mth pixel unit of the (4n+2)th row and a polarity of the mth pixel unit of the (4n+3)th row are opposite, and the polarity of the mth pixel unit of the (4n+3)th row and a polarity of the mth pixel unit of the (4n+4)th row are the same; and
a polarity of mth pixel unit of (4n+1)th column and a polarity of mth pixel unit of (4n+2)th column are opposite, the polarity of the mth pixel unit of the (4n+2)th column and a polarity of mth pixel unit of (4n+3)th column are the same, and the polarity of the mth pixel unit of the (4n+3)th column and a polarity of mth pixel unit of the (4n+4)th column are opposite;
wherein n is a non-positive integer and m is a positive integer.

9. The pixel structure of claim 8, wherein a plurality of polarities of a plurality of data signals in the data lines of adjacent frames having a plurality of the pixel units are converted.

10. The pixel structure of claim 8, wherein the pixel unit of ath row connects to ath scan line, and a is a positive integer.

11. The pixel structure of claim 8, wherein the pixel structure comprises a pixel unit with a red color, a pixel unit with a green color, and a pixel unit with a blue color.

12. The pixel structure of claim 8, wherein the pixel structure comprises a pixel unit with a red color, a pixel unit with a green color, a pixel unit with a blue color, and a pixel unit with a white color.

13. The pixel structure of claim 8, wherein the polarity of the mth pixel unit of the (4n+1)th row and a polarity of mth pixel unit of (4n+5)th row are the same.

14. The pixel structure of claim 8, wherein the polarity of the mth pixel unit of the (4n+1)th column and a polarity of mth pixel unit of (4n+5)th column are the same.

15. A liquid crystal display (LCD) panel comprising a pixel structure and a driving circuit to drive the pixel structure, and the pixel structure comprising a plurality of data lines, a plurality of scan lines, and a plurality of pixel units disposed between the data lines and the scan lines, wherein:
mth pixel unit of (4n+1)th row connects to mth data line, mth pixel unit of (4n+2)th row connects to the mth data line, mth pixel unit of the (4n+3)th row connects to (m+2)th data line, and mth pixel unit of (4n+4)th row connects to the (m+2)th data line;
a polarity of the mth pixel unit of the (4n+1)th row and a polarity of the mth pixel unit of the (4n+2)th row are the same, the polarity of the mth pixel unit of the (4n+2)th row and a polarity of mth pixel unit of the (4n+3)th row are opposite, and the polarity of the mth pixel unit of the (4n+3)th row and a polarity of the mth pixel unit of the (4n+4)th row are the same; and
a polarity of mth pixel unit of (4n+1)th column and a polarity of mth pixel unit of (4n+2)th column are the same, a polarity of mth the pixel unit of the (4n+2)th column and a polarity of mth pixel unit of (4n+3)th column are opposite, and a polarity of the mth pixel unit of the (4n+3)th column and a polarity of mth pixel unit of (4n+4)th column are the same;
wherein n is a non-positive integer and m is a positive integer.

16. The LCD panel of claim 15, wherein a plurality of polarities of a plurality of data signals in the data lines of adjacent frames having a plurality of the pixel units are converted.

17. The LCD panel of claim 15, wherein the pixel unit of ath row connects to ath scan line, and a is a positive integer.

18. The LCD panel of claim 15, wherein the pixel structure comprises a pixel unit with a red color, a pixel unit with a green color, and a pixel unit with a blue color.

19. The LCD panel of claim 15, wherein the pixel structure comprises a pixel unit with a red color, a pixel unit with a green color, a pixel unit with a blue color, and a pixel unit with a white color.
